(19) United States
(12) Patent Application Publication
(10) Pub. No.: US 2018/0119901 A1
(43) Pub. Date: May 3, 2018

(54) LASER NAME BADGE

(71) Applicant: Dustin A. Nielsen, Marana, AZ (US)

(72) Inventor: Dustin A. Nielsen, Marana, AZ (US)

(21) Appl. No.: 15/802,207

(22) Filed: Nov. 2, 2017

Related U.S. Application Data
(60) Provisional application No. 62/416,964, filed on Nov. 3, 2016.

(51) Int. Cl. F21L 4/08; F21V 23/04; F21V 21/14; F21V 33/00; A44C 3/00

(52) U.S. Cl. CPC F21L 4/08; F21V 23/0464; F21V 21/145; F21Y 2115/10; F21V 33/0004; A44C 3/001; F21V 23/0414

(57) ABSTRACT

An assembly which includes a light pack comprising an optically transparent portion to display a name/access badge, a first light emitting device attached to the light pack, a lasing device attached to the light pack, wherein the three individual elements are combined into a single, integral device, thereby providing wearable, hands-free lighting.

### CROSS REFERENCE TO RELATED APPLICATIONS

This non-provisional application claims priority to a United States Provisional Application having Ser. No. 62/416,964, and filed on Nov. 3, 2016.

### BACKGROUND

Most ID card holders and badges have only one function of holding an identification card of an employee/personnel for easier recognition. Additionally, most portable lights and lasing devices that are widely used in various workplaces are not easily accessible. In many cases, people have problems searching for and fumbling with a cell phone or a flashlight for functional light and/or lasing device. This device fixes this problem by having a lasing device and LED built into the name badge, or able to attach to an existing name badge, or access ID card holder. It provides a wearable light for people whom wear name badges or use a badge holder. By wearing this device, people will no longer have to waste time looking for a flashlight or lasing device. They will simply be able to access the one attached to their badge.

Additionally, usage of a flash light or lasing device requires a hand to hold them. It prevents the use of one or more hands that could be used for other purposes. For certain applications, particularly for nurses, it is common to hold a lighting device or a lasing device in their hands while taking care of patients or guiding stretchers. Wearing this device will allow the wearer hands free lighting and laser pointing, allowing them to work more efficiently.

Moreover, other wearable lighting devices tend to interrupt body movement of the wearer. Since the device is built into or attached to the name badge or access card holder that is already being worn, there will be no additional disturbance of body movement.

### BRIEF DESCRIPTION OF THE DRAWINGS

This invention will be better understood from a reading of the following description taken in conjunction with the drawings in which like reference designators are used to designate like elements, and is which:

FIG. 1. is a front elevation view of a first embodiment of Applicant's LED laser name badge;

FIG. 2. is a front elevation view of a second embodiment of Applicant's LED laser name badge; and

FIG. 3. is a front elevation view of a third embodiment of the Applicant's LED laser name badge.

### DESCRIPTION

While this invention is susceptible to embodiments in many different forms, there is shown in the drawings and herein described in detail, features, structures, or characteristics of the invention as demonstrated in various preferred embodiments. These embodiments are to be considered for illustrative purposes and as an exemplification of the principles of the invention and are not intended to limit the broad aspects of the invention to the specific embodiments illustrated herein. The features, structures, or characteristics of the invention as disclosed in any one preferred embodiment, for example, may be rearranged or combined with the features, structures or characteristics in any other embodiment. One skilled in the relevant art will also recognize that the invention may be practiced without one or more of the specific details, or with other methods, components, materials, and so forth. In other instances, well-known structures, materials, or operations are not shown or described in detail to avoid obscuring aspects of the invention.

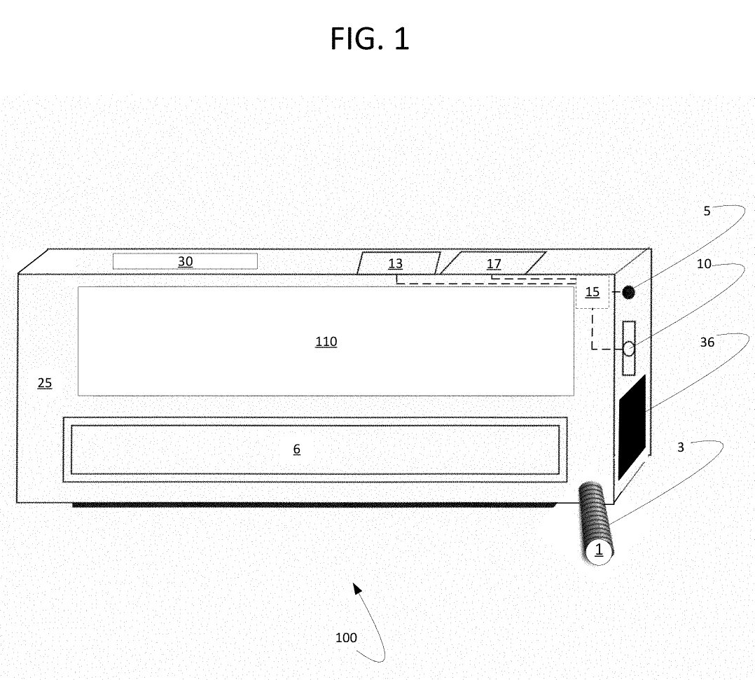

FIG. 1. illustrates a first embodiment of Applicant's LED laser name badge 100. Assembly 100 is of a sufficient size to enclose an ID or access card. A front portion 110 of assembly 100 is formed from an optically transparent material so that an access card is visible when inserted in the assembly 100.

A light pack 25 comprises one or more visible-light emitting devices. In certain embodiments, light pack 25 comprises a hexagonal shape. A photocell 17 is disposed on an upper portion of assembly 25. Photocell 17 generates power from ambient light, wherein that power is stored in battery 15.

Flex conduit 3 is attached to, and extends outwardly from, a surface of assembly 100. A visible-light emitting device 1 is disposed on a distal end of flexible conduit 3. In certain embodiments, visible-light emitting device 1 comprises one or more light emitting diodes (“LEDs”).

An LED switch 10 is interconnected to battery 15 and to visible-light emitting device 1. LED switch 10 is used to turn on and off the LED or other visible light 1.

In certain embodiments the LED or other visible light 1 emits visible light. In another embodiment the LED or the other visible light 1 emits electromagnetic radiation in infrared spectrum. In another embodiment the LED or the other visible light 1 emits electromagnetic radiation in the ultraviolet spectrum.

In certain embodiments, a laser pointing device 5 is attached to the surface of assembly 100.

An attachment means 30 is attached to a surface of assembly 100. In certain embodiments, attachment means 30 comprises a pin. In certain embodiments, attachment means 30 comprises a lanyard. In certain embodiments, attachment means 30 comprises a magnet. In certain embodiments, attachment means 30 comprises a clip.

Assembly 100 is formed to include a card insertion aperture 36. The card insertion aperture 36 must be big enough so that an ID card or an access card can be inserted. At the same time, the card insertion aperture 36 shall be small enough that the ID card or the access card doesn't easily slide out of the card holder 35.

With further reference to FIG. 1. a light/dark sensor 13 is attached to a side of the light pack 25. The light/dark sensor 13 automatically turns on the LED or other visible light 1 when ambient light intensity falls below a pre-set threshold level. The light/dark sensor 13 automatically turns off the LED or other visible light 1 when the ambient light intensity exceeds that threshold level. LED or other visible light 1 can also be turned on and off manually by operating the LED switch 10.

A battery 15 is disposed within assembly 100. In certain embodiments, battery 15 comprises a rechargeable battery.

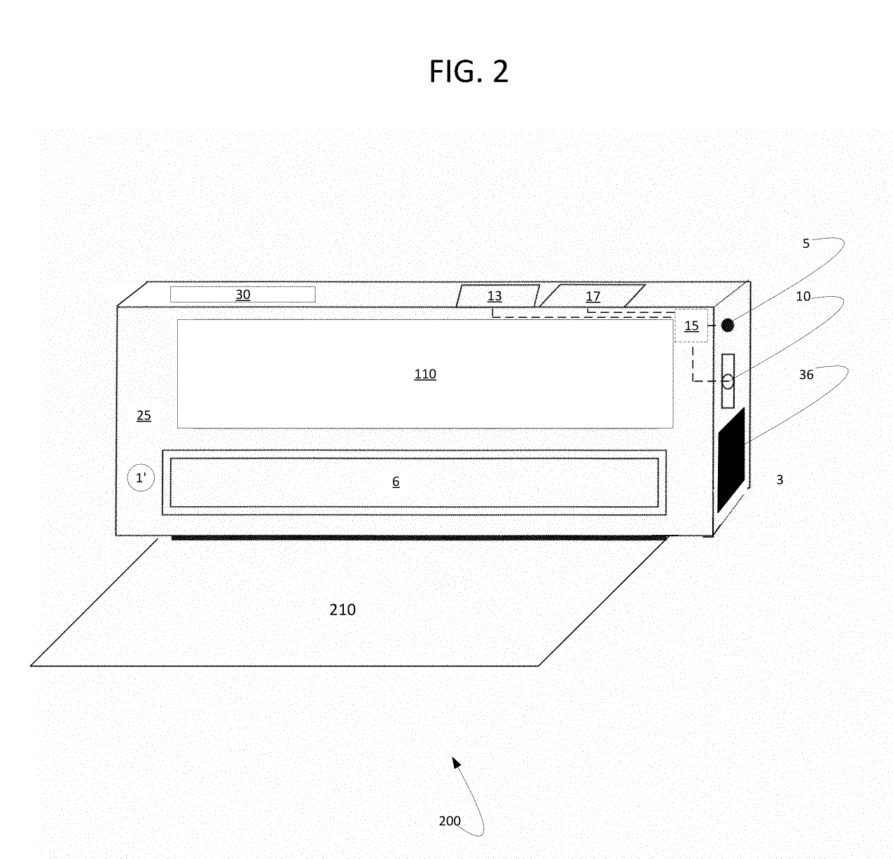

FIG. 2 illustrates a second embodiment 200 of Applicant's assembly. In the illustrated embodiment of FIG. 2, assembly 200 does not comprise flexible conduit 3. Rather, assembly 200 comprises a door 210 that is pivotally attached to assembly 200 and extends outwardly therefrom.

Flip Door 210 operates as a switch. Opening flip door 210, as shown in FIG. 2, turns on visible-light emitting device 1′, which is disposed on assembly 200. Closing flip door 210 will turn off the LED or other visible light 1′.

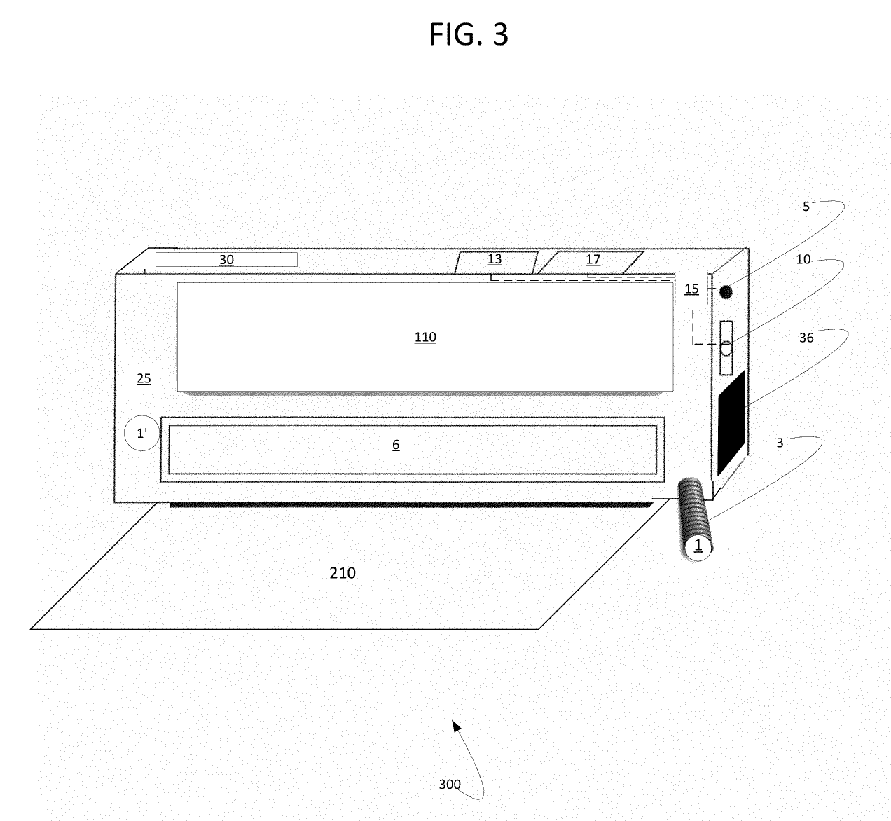

FIG. 3 illustrates a third embodiment of Applicant's assembly. In the illustrated embodiment of FIG. 3, assembly 300 comprises both flexible conduit and visible-light emitting device 1 in combination with flip door 210 and visible light-emitting device 1′.

While the preferred embodiments of the present invention have been illustrated in detail, it should be apparent that modifications and adaptations to those embodiments may occur to one skilled in the art without departing from the scope of the present invention.

I claim:

1. A laser name badge, comprising:
a light pack formed to include an aperture extending inwardly;
an attachment means disposed on said light pack for displaying said light pack;
a first light emitting device attached to and extending outwardly from said light pack, and interconnected to said battery;
a light/dark sensor interconnected to said first light emitting device;
a second light emitting device comprising a lasing device disposed on a surface of said light pack and interconnected to said battery;
a power source disposed within said light pack and interconnected to said first light emitting device and to said lasing device.

2. The laser name badge of claim 1, wherein said power source comprises a battery.

3. The laser name badge of claim 1, wherein the power source comprises a photovoltaic cell.

4. The laser name badge of claim 1, wherein the lasing device emits visible light.

5. The laser name badge of claim 1, further comprising a flexible conduit having a first end attached to said surface, wherein said first light emitting device is disposed in a second an opposing end.

6. The laser name badge of claim 1, further comprising:
a flip door pivotably attached to said surface and movable between a first/closed configuration and a second/open configuration;
a second light emitting device;
wherein:
said first light emitting device is disposed beneath said flip door when placed in said closed configuration, and wherein said first light emitting device is not disposed beneath said flip door when placed in said open configuration; and
said second light emitting device is not disposed beneath said flip door when placed in said closed configuration.

7. The laser name badge of claim 1, wherein said light emitting device is configured to turn on and off automatically using said light/dark sensor.

8. The laser name badge of claim 1, wherein said first light emitting device further comprises a manual on/off switch.

9. The laser name badge of claim 8, wherein an intensity of electromagnetic radiation emitted by the first visible-light emitting device can be adjusted.

10. The laser name badge of claim 1, wherein said first light emitting device emits electromagnetic radiation in the visible spectrum.

11. The laser name badge of claim 1, wherein said first light emitting device emits electromagnetic radiation in the infrared spectrum.

12. The laser name badge of claim 1, wherein said first light emitting device emits electromagnetic radiation in the ultraviolet spectrum.
